(19) United States
(12) Patent Application Publication
(10) Pub. No.: US 2003/0154047 A1
(43) Pub. Date: Aug. 14, 2003

(54) Tester for mixed signal semiconductor device and method of testing semiconductor device using the same

(75) Inventors: Byoung-Ok Chun, Chungcheongnam-do (KR); Kun-Sun Lee, Chungcheongnam-do (KR); Weon-Seob Shim, Kyungki-do (KR); Jae-Young Kim, Chungcheongnam-so (KR); Ji-Sup Lee, Kyungki-do (KR); Dong-Youn Nam, Kyungki-do (KR)

Correspondence Address: MARGER JOHNSON & McCOLLOM, P.C., 1030 S.W. Morrison Street, Portland, OR, 97205, US

(73) Assignee: Samsung Electronics Co., Ltd., Kyunkgki-do (KR)

(21) Appl. No.: 10/300,491

(22) Filed: Nov. 19, 2002

(30) Foreign Application Priority Data
Feb. 8, 2002 (KR) 02-7530

(51) Int. Cl. G06F 19/00

(52) U.S. Cl. 702/118

(57) ABSTRACT

A tester for a mixed signal semiconductor device having a reconstructed digital tester, and a method of testing a semiconductor device using the same are provided. A digital tester electrically tests a digital device and is controlled by a first controller. A metrology instrument module comprising an analog source generator for applying an analog signal to a semiconductor device, an analog waveform digitizer for analyzing the analog signal into a digital signal, and a personal computer including a second controller forms a part of the digital tester, and the first controller is connected to the metrology instrument module through an interface line.

### BACKGROUND OF THE INVENTION

1. Field of the Invention

The present invention relates to testing equipment for a semiconductor device, and more particularly, to a tester for a mixed signal semiconductor device and a method of testing a semiconductor device using the same.

2. Description of the Related Art

In general, the electrical functions of semiconductor devices are tested by a tester after the semiconductor devices are manufactured. In this case, semiconductor devices under test are classified into three kinds of semiconductor devices, such as a digital semiconductor device, an analog semiconductor device, and a mixed signal semiconductor device, according to the kinds of electrical signals handled in the semiconductor devices.

Since the three kinds of semiconductor devices have different signals handled in the semiconductor devices, testers for testing the electrical functions of the semiconductor devices are also classified into three kinds of testers. Thus, the electrical function of a semiconductor device for handling digital signals is tested by a digital tester, the electrical function of a semiconductor device for handling analog signals is tested by an analog tester, and the electrical function of a semiconductor device for handling mixed signals is tested by a mixed signal tester.

Most mixed signal semiconductor devices among the three kinds of semiconductor devices are system on chip (SOC) devices. There is a rapidly increasing demand for the mixed signal semiconductor device. This is because listening to music and viewing moving pictures via computer are increasing by common due to the large capacity of personal computers and the development of the Internet. Thus, a tester for the mixed signal semiconductor device should have a special structure in which analog signals and digital signals are simultaneously handled. Most semiconductor device manufacturers have only digital testers.

In order to solve this problems, costly testers for and mixed signal semiconductor devices read to be purchased digital testers read to be retired. But this solution is prohibitively expensive.

### SUMMARY OF THE INVENTION

To solve the above problems, it is a first object of the present invention to provide a tester, that is capable of testing a semiconductor device for handling mixed signals by incarcerating a new metrology instrument module in a conventional digital tester.

It is a second object of the present invention to provide a method of testing a semiconductor device using the tester for a mixed signal semiconductor device.

Accordingly, to achieve the first object, there is provided a tester for a mixed signal semiconductor digital device. The tester includes a digital tester for electrically testing a digital device, the tester being controlled by a first controller, a metrology instrument module comprising an analog source generator for applying an analog signal to a semiconductor device, an analog waveform digitizer for converting the analog signal into a digital signal, and a personal computer in which a second controller is incorporated, which metrology instrument module incorporated additionally installed in the digital tester, and an interface line through which the first controller is connected to the metrology instrument module.

According to a preferred embodiment of the present invention, it is preferable that the interface line is a local area network (LAN) cable and that a transmission control protocol/Internet protocol (TCP/IP) is used as the interface line.

It is also preferable that a method in which the digital tester and the metrology instrument module transmit and receive a signal through the TCP\IP interface line is a socket message transmission method.

It is also preferable that the personal computer transmits and/or receives a signal to and/or from the analog source generator or the analog waveform digitizer via a VMEbus extensions for instrumentation (VXI) bus in the metrology instrument module.

To achieve the second object, there is provided a method of testing a mixed signal semiconductor device. The method includes starting the test for the mixed signal semiconductor device, using a digital tester, performing general function tests for the mixed signal semiconductor device, using the digital tester, performing a mixed signal function test, using a metrology instrument module connected to the digital tester through an interface line, and binning the results of tests by synthesizing the results of the general function tests and the mixed signal function test, using the digital tester.

According to a preferred embodiment, it is preferable that the general function tests include an open/short test, a leakage current test, and a function test, and an analog/digital conversion (ADC) function or a digital/analog conversion (DAC) function is tested in the mixed signal function test, or both the ADC and DAC function are tested in the mixed signal function test.

The method of testing the ADC function includes transmitting a message that instructs to apply an analog signal to the semiconductor device, to a second controller of the metrology instrument module from a first controller of the digital tester, applying an analog waveform to the semiconductor device from an analog source generator of the metrology instrument module, transmitting another message that the analog signal has been applied to the semiconductor device to the first controller of the digital tester from the second controller of the metrology instrument module, capturing a digital signal output from the semiconductor device and generating data, using the digital tester, and processing the generated data through a digital signal processor (DSP).

The step of capturing a digital signal and generating data is performed using a digital memory of the digital tester, and in the step of processing the generated data through a DSP, the noise characteristics of an analog signal are analyzed by a fast fourier transform (FFT) routine, which the semiconductor device performs the ADC function.

The method of testing the DAC function includes transmitting a message that a digital signal is applied to the semiconductor device to the second controller of the metrology instrument module from the first controller of the digital tester, capturing an analog signal output from the semiconductor device and storing the captured analog signal in a file format, using an analog waveform digitizer of the metrology instrument module, reading the stored file and processing the stored file through a digital signal processor (DSP), using the metrology instrument module, and transmitting the result of the DSP to the first controller of the digital tester from the second controller of the metrology instrument module.

In the step of processing the stored file through a DSP the noise characteristics of an analog signal are analyzed by a fast fourier transform (FFT) routine, and the semiconductor device performs the DAC function.

According to the present invention, a semiconductor device for handling mixed signals can be tested without purchasing a costly tester for a mixed signal semiconductor device, and a tester having a desired configuration can be implemented without the constraints imposed by conventional testers.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram illustrating the structure of a tester for a mixed signal semiconductor device according to the present invention and signal interchange with a semiconductor device under test;

FIG. 2 is a flowchart illustrating a method of testing a semiconductor device using a tester for a mixed signal semiconductor device according to the present invention;

FIG. 3 is a flowchart illustrating a method of testing an analog/digital conversion (ADC) semiconductor device using a tester for a mixed signal semiconductor device according to the present invention; and

FIG. 4 is a flow chart illustrating a method of testing a digital-to-analog converter (DAC) semiconductor device using a tester for a mixed signal semiconductor device according to the present invention.

### DETAILED DESCRIPTION OF THE INVENTION

The present invention will be described more fully hereinafter with reference to the accompanying drawings in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

A digital tester mentioned in the specification has a comprehensive meaning and is not limited to a specific digital tester, such as Advantester.

The present invention may be practiced in other ways without deviating the scope and the essential features of the present invention. For example, in preferred embodiments, a system bus controlled by a second controller of a metrology instrument module is a VMEbus extensions for instrumentation (VXI) bus, but may be a PCI extensions for instrumentation (PXI). Also, an interface line through which the digital tester is connected to the metrology instrument module is a LAN cable, but may be replaced with a communication cable, such as a RS232 port. Thus, the description in the following preferred embodiments is exemplified but is not limited the embodiments set forth herein.

Structure of tester for mixed signal semiconductor device and method of testing semiconductor device using the same

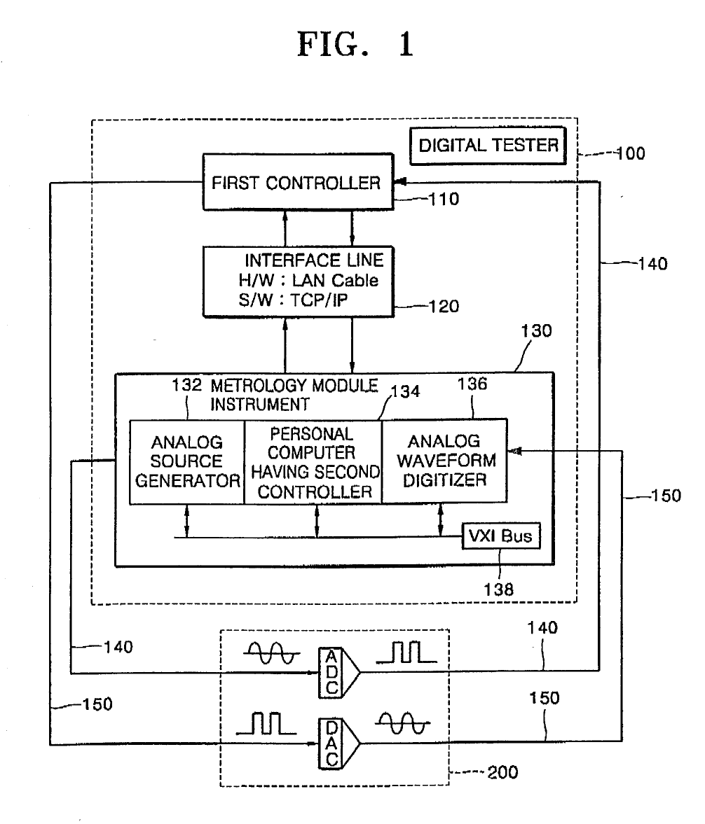

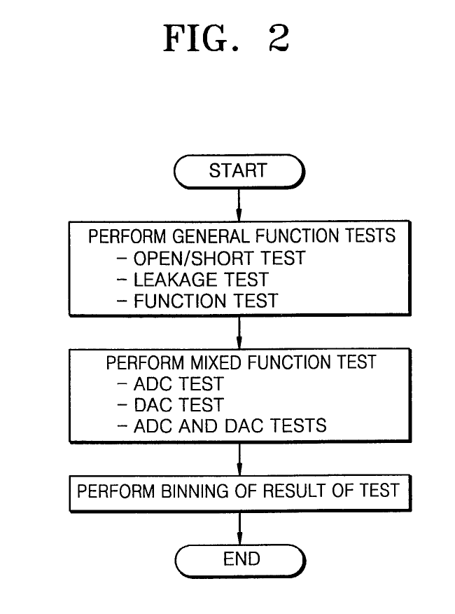

FIG. 1 is a block diagram illustrating the structure of a tester for a mixed signal semiconductor device according to the present invention and signal interchange with a semiconductor device under test, and FIG. 2 is a flow chart illustrating a method of testing a semiconductor device using the tester for a mixed signal semiconductor device according to the present invention.

Referring to FIG. 1, the tester for a mixed signal semiconductor device according to the present invention includes a digital tester 100, a metrology instrument module 130 that is incorporated in the digital tester 100, and an interface line 120 through which the digital tester 100 is connected to the metrology instrument module 130.

In the present invention, a T-3347 model tester manufactured by Advantest Corporation is used as the digital tester 100. The T-3347 model of Advantest Corporation operated at a speed of 40 MHz and has 256 channels and eight power supplies. The system configuration is adequate to electrically test a digital test block of a conventional mixed signal semiconductor device. However, The T-3347 model doesn't have an analog source generator and an analog waveform digitizer, which are required to electrically test an analog test block for a mixed signal semiconductor device, and thus is used to test only a digital signal semiconductor device.

In order to solve the problem, the metrology instrument module 130 is additionally installed in the digital tester 100. The metrology instrument module 130 includes an analog source generator 132 for applying an analog signal to a semiconductor device under test, i.e., mixed signal semiconductor device 200, an analog waveform digitizer 136 for analyzing an analog signal output from the mixed signal semiconductor device 200 into a digital signal, and a personal computer 134 in which a second controller, for controlling the metrology instrument module 130 and being required to communicate a message with the digital tester 100 is installed.

An analog source generator 132 has a speed of up to 25.5 MHz; the analog waveform digitizer 136 has 20 sampling prints per second; and a personal computer 134 in which the second controller is built runs Windows 2000 as an operating system (OS). All may be part of the metrology instrument module 130.

Transmission and reception between the personal computer 134 having the second controller, the analog source generator 132, and the analog waveform digitizer 136 preferably is performed via a VMEbus extensions for instrumentation (VXI) bus 138. Alternative forms are within the spirit and scope of the invention.

A mixed signal test can be performed by transmitting and/or receiving a message between a first controller 110 of the digital tester 100 and the second controller of the metrology instrument module 130, through the interface line 120 using a local area network (LAN) cable and by a socket message transmission method, which is an application of a transmission control protocol/Internet protocol (TCP/IP). Preferably, for this purpose, a LAN interface card is previously installed in the digital tester 100 and the metrology instrument module 130.

A method of electrically testing a semiconductor device using the tester for a mixed signal semiconductor device will be described with reference to FIGS. 1 and 2. First, the digital tester 100 starts an electrical test for the mixed signal semiconductor device 200. After that, the digital tester 100 performs general function tests, such as an open/short test, a leakage current test, and a function test in a digital manner. Next, a mixed signal function test is performed with the aid of the metrology instrument module 130 and the digital tester 100 and using a subroutine program in a test program of the digital tester 100. An analog/digital conversion (ADC) function test or a digital/analog conversion (DAC) function test may be performed using the subroutine program, and the ADC/DAC function tests are simultaneously performed using subroutine calls. Last, the digital tester 100 performs binning where by the results of a test are synthesized to include the results of the general function tests and those of the mixed signal function test.

First Embodiment

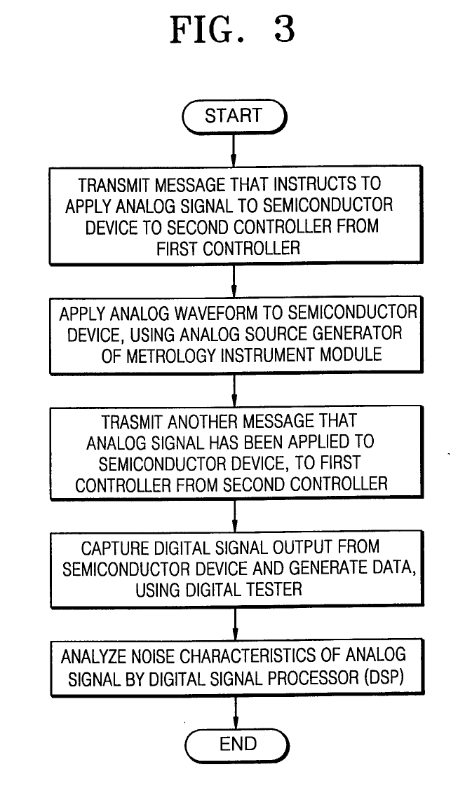

FIG. 3 is a flowchart illustrating a method of testing an analog/digital conversion (ADC) semiconductor device using a tester for a mixed signal semiconductor device according to the present invention.

A method of testing an ADC semiconductor device using the tester for a mixed signal semiconductor device according to the present invention will be described with reference to an ADC signal interchange line 140 of FIG. 1 and FIG. 3. After the digital tester 100 finishes the general function tests, the first controller of the digital tester 100 transmits a message, that instructs to apply an analog signal to the ADC semiconductor device 200 using the analog source generator 132, to the second controller of the metrology instrument module 130. After the message is received, the analog source generator 132 of the metrology instrument module 130 applies an analog waveform to an ADC semiconductor device 200. Next, the second controller of the metrology instrument module 130 transmits another message. that the analog signal has been applied to the ADC semiconductor device 200, to the first controller of the digital tester 100.

After the transmission of the message is completed, the digital tester 100 captures a digital signal output from the ADC semiconductor device 200 and generates data. In case the digital tester 100 is Advantester, the Advantester captures the digital signal using a digital memory, i.e., function fail memory of an algorithmic logic pattern generator (ALPG) and generates data. After that, the noise characteristics of the analog signal are analyzed by a digital signal processor (DSP), e.g. by applying a fast fourier transform (FFT).

Second Embodiment

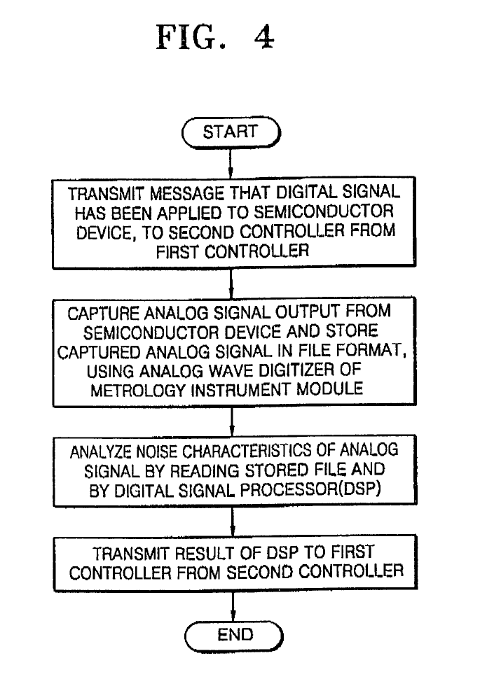

FIG. 4 is a flow chart illustrating a method of testing a digital-to-analog converter (DAC) semiconductor device using a tester for a mixed signal semiconductor device according to the present invention.

A method of testing a DAC semiconductor device using the tester for a mixed signal semiconductor device according to the present invention will be described with reference to a DAC signal interchange line 150 of FIG. 1 and FIG. 4. After the digital tester 100 finishes the general function tests, the first controller of the digital tester 100 transmits a message, that a digital signal is applied to the DAC semiconductor device 200, to the second controller of the metrology instrument module 130. After the transmission of the message is completed, the analog waveform digitizer 136 of the metrology instrument module 130 captures an analog signal output from the DAC semiconductor device 200, analyzes the captured analog signal and stores the analog signal in a file format. The second controller of the metrology instrument module 130 analyzes the noise characteristics of the analog signal by reading the file and by a digital signal processor (DSP), e.g. by applying a fast fourier transform (FFT). The final result of the DSP is transmitted to the first controller of the digital tester 100 from the second controller of the metrology instrument module 130.

Third Embodiment

In the first and second embodiments, the method of testing only the ADC semiconductor memory device or the DAC semiconductor device using the tester for a mixed signal semiconductor device has been described. However, there is a specific semiconductor device for handling an ADC signal and a DAC signal. In this case, the above-mentioned ADC test and DAC test are performed separately. Since a detailed method thereof has been described in the first and second embodiments, a description thereof will be omitted to avoid redundancy.

As described above, the present invention has the following advantages.

First, a semiconductor device for handling a mixed signal can be tested in a digital tester without purchasing a costly tester for a mixed signal semiconductor device, and thus costs can be reduced.

Second, a remaining digital tester can be utilized, and thus the installed tester base is not rendered obsolete.

Third, a tester system having a configuration desired by a user can be implemented without the constraints imposed by conventional testers. In the case of a conventional tester, an operating system (OS) which operates in a first controller may be compatible with only system configuration. Thus, it is difficult for a user to analyze the tester and to install additional equipment. However, according to the present invention, a tester having a desired configuration can be implemented, and simultaneously an independent tester can be achieved by additionally installing a metrology instrument module using a general OS, such as Windows 2000, and by connecting the metrology instrument module to a general LAN cable.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A tester for a mixed signal semiconductor device, the tester comprising:
a digital tester for electrically testing a digital device, the digital tester including a first controller; a metrology instrument module comprising an analog source generator for applying an analog signal to a semiconductor device, an analog waveform digitizer for converting the analog signal into a digital signal, and a personal computer including a second controller and an interface line through which the first controller is connected to the metrology instrument module.

2. The tester of claim 1, wherein the interface line is a local area network (LAN) cable.

3. The tester of claim 1, wherein a transmission control protocol/Internet protocol (TCP/IP) is used as the interface line.

4. The tester of claim 3, wherein a method in which the first controller and the metrology instrument module transmit and receive a signal through the TCP\IP interface line is a socket message transmission method.

5. The tester of claim 1, wherein the personal computer transmits and/or receives a signal to and/or from the analog source generator or the analog waveform digitizer via a VMEbus extensions for instrumentation (VXI) bus in the metrology instrument module.

6. A method of testing a mixed signal semiconductor device, the method comprising:
initiating test for the mixed signal semiconductor device using a digital tester;
performing general function tests for the mixed signal semiconductor device using the digital tester;
performing a mixed signal function test, using a metrology instrument module that is additionally installed in the digital tester and is connected to the digital tester through an interface line; and
binning the results of test by synthesizing the results of the general function tests and the mixed signal function test, using the digital tester.

7. The method of claim 6, wherein the general function tests include an open/short test, a leakage current test and a function test.

8. The method of claim 6, wherein an analog/digital conversion (ADC) function is tested in the mixed signal function test.

9. The method of claim 6, wherein a digital/analog conversion (DAC) function is tested in the mixed signal function test.

10. The method of claim 6, wherein the ADC and DAC functions are tested in the mixed signal function test.

11. The method of claim 8, wherein a method of testing the ADC function comprises:
transmitting a message, that instructs to apply an analog signal to the semiconductor device, to a second controller of the metrology instrument module from a first controller of the digital tester;
applying an analog waveform to the semiconductor device from an analog source generator of the metrology instrument module;
transmitting another message, that the analog signal has been applied to the semiconductor device, to the first controller of the digital tester from the second controller of the metrology instrument module;
capturing a digital signal output from the semiconductor device and generating data, using the digital tester; and
processing the generated data through a digital signal processor (DSP).

12. The method of claim 11, wherein step of capturing a digital signal and generating data is performed using a digital memory of the digital tester.

13. The method of claim 11, wherein in the step of processing the generated data through a DSP, the noise characteristics of an analog signal are analyzed by a fast fourier transform (FFT) routine.

14. The method of claim 11, wherein the semiconductor device can perform the ADC function.

15. The method of claim 9, wherein a method of testing the DAC function comprises:
transmitting a message, that a digital signal is applied to the semiconductor device, to the second controller of the metrology instrument module from the first controller of the digital tester;
capturing an analog signal output from the semiconductor device and storing the captured analog signal in a file format using an analog waveform digitizer of the metrology instrument module;
reading the stored file and processing the stored file through a digital signal processor (DSP) using the metrology instrument module; and
transmitting the result of the DSP to the first controller of the digital tester from the second controller of the metrology instrument module.

16. The method of claim 15, wherein in the step of processing the stored file through a DSP, the noise characteristics of an analog signal are analyzed by a fast fourier transform (FFT) routine.

17. The method of claim 15, wherein the semiconductor device can perform the DAC function.
